(19) United States
(12) Patent Application Publication
(10) Pub. No.: US 2010/0283569 A1
(43) Pub. Date: Nov. 11, 2010

(54) ELECTROMAGNETIC WINDING ASSEMBLY

(76) Inventors: Ping-Kun LEE, Kaohsiung (TW); Jia-Yush YEN, Taipei City (TW); Kai-Chen KUO, Kaohsiung (TW); Yi-Chih LAI, Taipei City (TW); Cheng-Ju WU, Taipei City (TW)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/436,510

(22) Filed: May 6, 2009

(51) Int. Cl. H01F 27/28

(52) U.S. Cl. 336/180

(57) ABSTRACT

An electromagnetic winding assembly includes first and second housing halves and first and second conductive units provided on the first and second housing halves, respectively. The first and second housing halves are detachably connected to each other so as to define cooperatively a core-receiving space therebetween and to connect electrically the first conductive unit with the second conductive unit such that the first conductive unit cooperates with the second conductive unit to form at least one coil-like electrical conductor configured to be wound around a core received in the core-receiving space.

### BACKGROUND OF THE INVENTION

1. Field of the Invention

This invention relates to an electromagnetic winding assembly, more particularly to an electromagnetic winding assembly including first and second conductive units that are detachably connected to each other to form a coil-like electrical conductor.

2. Description of the Related Art

FIG. 1 illustrates a conventional electromagnetic property measuring apparatus that includes a measuring device 300 and a pair of electrical wires 200. In operation, the electrical wires 200 are wound around an annular steel plate 100 to be tested, and are connected to the measuring device 300 for measuring the electromagnetic properties of the steel plate 100. Since the winding of the electrical wires 200 around the steel plate 100 is conducted manually, not only is it relatively time-consuming, but the spacings among adjacent turns of the winding of each electrical wire 200 cannot be well controlled and are thus inconsistent throughout the entire winding, which can lead to inaccurate measurement of the electromagnetic properties. In addition, the insulator sheath of each electrical wire 200 is likely to be worn out after a period of time due to repeated winding and unwinding operations during the use thereof.

### SUMMARY OF THE INVENTION

Therefore, the object of the present invention is to provide an electromagnetic winding assembly that can overcome the aforesaid drawbacks associated with the prior art.

According to this invention, there is provided an electromagnetic winding assembly that comprises: first and second housing halves; and first and second conductive units provided on the first and second housing halves, respectively. The first and second housing halves are detachably connected to each other so as to define cooperatively a core-receiving space therebetween and to connect electrically the first conductive unit with the second conductive unit such that the first conductive unit cooperates with the second conductive unit to form at least one coil-like electrical conductor configured to be wound around a core received in the core-receiving space.

### BRIEF DESCRIPTION OF THE DRAWING

Other features and advantages of the present invention will become apparent in the following detailed description of the preferred embodiments of this invention, with reference to the accompanying drawings, in which:

FIG. 1 is a schematic view of a conventional electromagnetic property measuring apparatus;

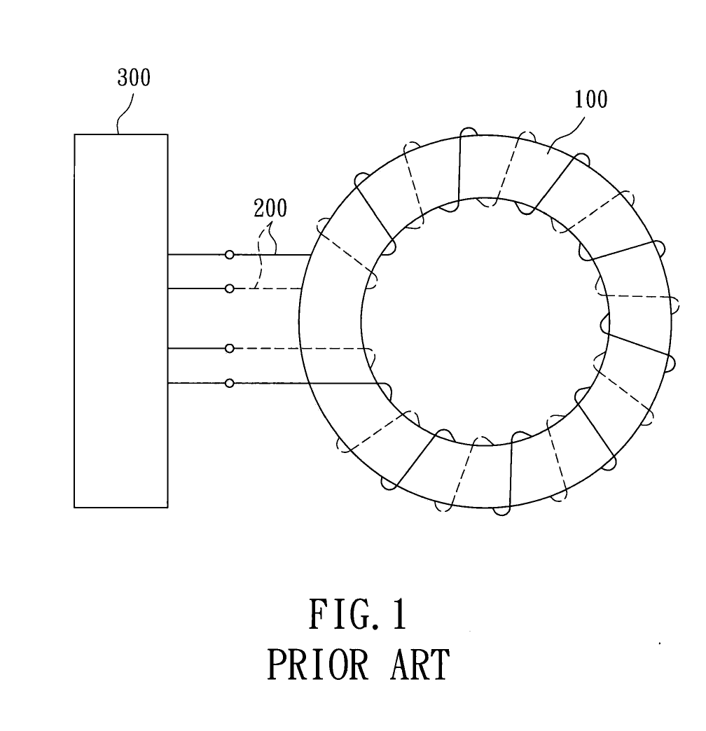

FIG. 2 is an exploded perspective view of the first preferred embodiment of an electromagnetic winding assembly according to this invention;

FIG. 3 is an exploded perspective view of a housing half of the first preferred embodiment;

FIG. 4 is a schematic top view of the first preferred embodiment;

FIG. 5 is a sectional view taken along line V-V in FIG. 4; and

FIG. 6 is a fragmentary sectional view of the second preferred embodiment of an electromagnetic winding assembly according to this invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

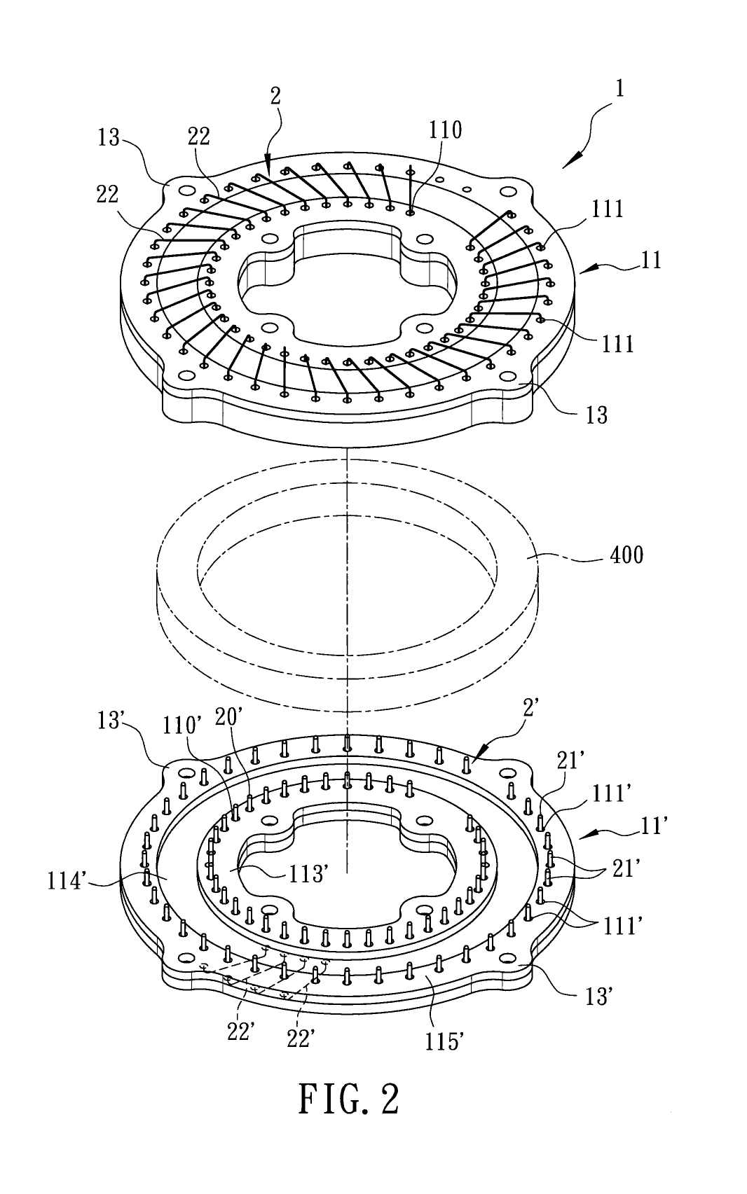

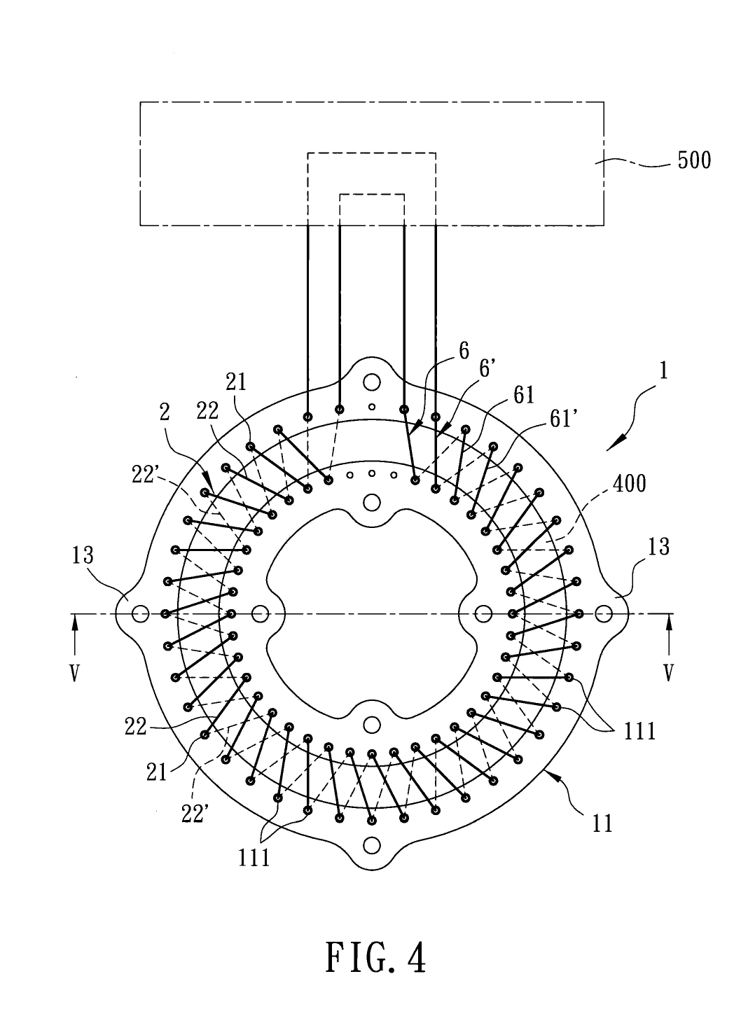

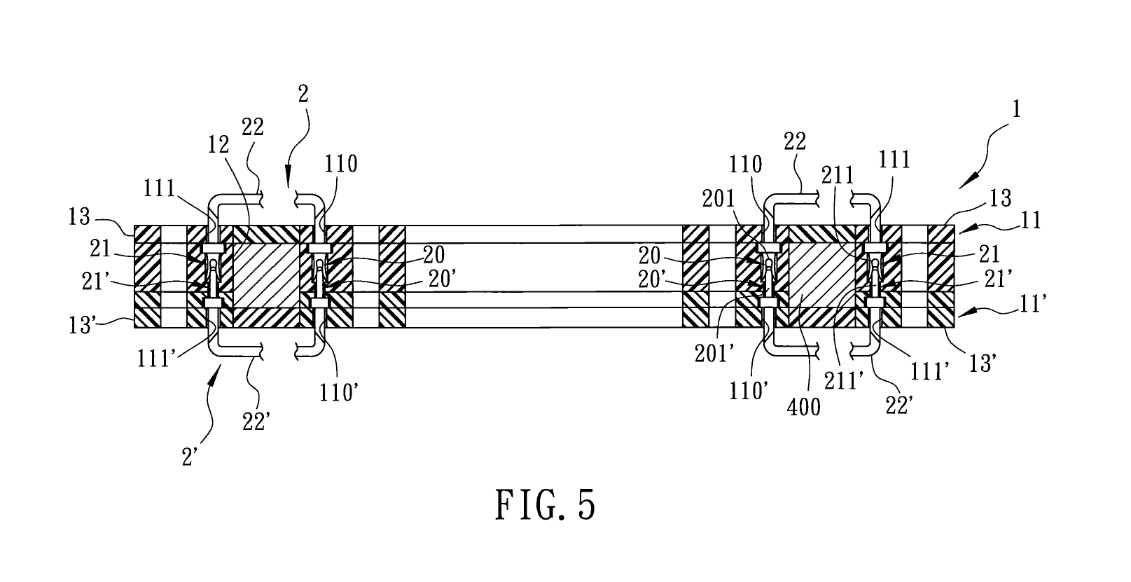

FIGS. 2 to 5 illustrate the first preferred embodiment of an electromagnetic winding assembly 1 according to this invention. The electromagnetic winding assembly 1 can be connected electrically to an electromagnetic property measuring device 500 (see FIG. 4) for measuring electromagnetic properties of a core 400, which is in the form of an electromagnetic steel plate in this embodiment. Since the electromagnetic property measuring device 500 is commercially available and is not the subject of improvement of this invention, details thereof are omitted herein. The electromagnetic winding assembly 1 includes first and second housing halves 11, 11′, and first and second conductive units 2, 2′ provided on the first and second housing halves 11, 11′, respectively. The first and second housing halves 11, 11′ are detachably connected to each other so as to define cooperatively a core-receiving space 12 therebetween (see FIG. 5) and to connect electrically the first conductive unit 2 with the second conductive unit 2′ such that the first conductive unit 2 cooperates with the second conductive unit 2′ to form a pair of coil-like electrical conductors 6, 6′ wound around the core 400 that is received in the core-receiving space 12 (see FIG. 5). Each of the coil-like electrical conductors 6, 6′ has a plurality of turns 61, 61′. The turns 61 of one of the coil-like electrical conductors 6 are alternately disposed with the turns 61′ of the other of the coil-like electrical conductors 6′.

Each of the first and second housing halves 11, 11′ is formed with a plurality of angularly displaced inner through-holes 110, 110′ and a plurality of angularly displaced outer through-holes 111, 111′. The first conductive unit 2 includes a plurality of first inner connectors 20 that are inserted respectively into the inner through-holes 110 in the first housing half 11, a plurality of first outer connectors 21 that are inserted respectively into the outer through-holes 111 in the first housing half 11, and a plurality of angularly displaced first conductive wires 22, each of which is connected electrically to a respective one of the first inner connectors 20 and a respective one of the first outer connectors 21 through welding techniques. The second conductive unit 2′ includes a plurality of second inner connectors 20′ that are inserted respectively into the inner through-holes 110′ in the second housing half 11′, a plurality of second outer connectors 21′ that are inserted respectively into the outer through-holes 111′ in the second housing half 11′, and a plurality of angularly displaced second conductive wires 22′, each of which is connected electrically to a respective one of the second inner connectors 20′ and a respective one of the second outer connectors 21′ through welding techniques. Each of the first inner connectors 20 is connected electrically to a respective one of the second inner connectors 20′. Each of the first outer connectors 21 is connected electrically to a respective one of the second outer connectors 21′. Preferably, the first and second conductive wires 22, 22′ employed in the electromagnetic winding assembly 1 are enameled wires. It should be noted herein that the first conductive wires 22 may be connected electrically and respectively to the first inner connectors 20 and to the first outer connectors 21 through other techniques known in the art.

In this embodiment, each of the first inner connectors 20 and the first outer connectors 21 has a socket portion 201, 211. Each of the second inner connectors 20′ and the second outer connectors 21′ has a prong portion 201′, 211′. The prong portion 201′, 211′ of each of the second inner connectors 20′ and the second outer connectors 21′ extends outwardly of the respective one of the inner and outer through-holes 110′, 111′ in the second housing half 11′ and into a respective one of the inner and outer through-holes 110, 111 in the first housing half 11 to engage releasably the socket portion 201, 211 of the respective one of the first inner connectors 20 and the first outer connectors 21 in a male-and-female engaging manner.

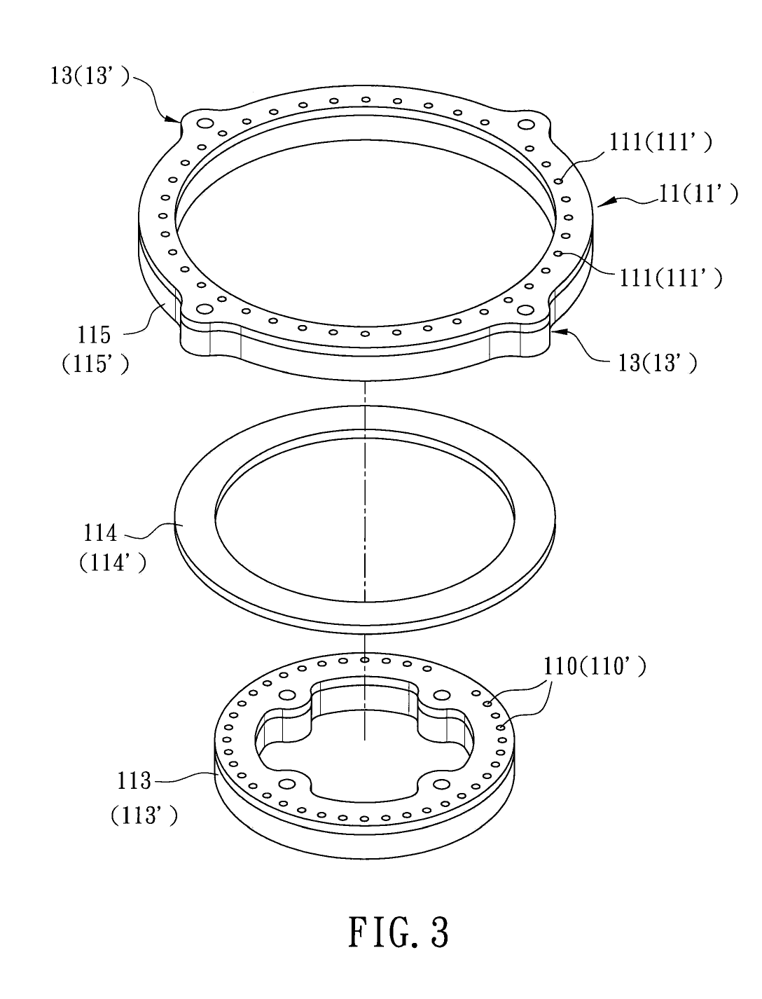

As illustrated in FIG. 3, each of the first and second housing halves 11, 11′ includes an inner ring 113, 113′, an outer ring 115, 115′ surrounding the inner ring 113, 113′, and a middle ring 114, 114′ interconnecting the inner and outer rings 113, 113′, 115, 115′. The inner through-holes 110, 110′ in the first and second housing halves 11, 11′ are formed in the inner rings 113, 113′ of the first and second housing halves 11, 11′, respectively. The outer through-holes 111, 111′ in the first and second housing halves 11, 11′ are formed in the outer rings 115, 115′ of the first and second housing halves 11, 11′, respectively. Each of the outer rings 115, 115′ of the first and second housing halves 11, 11′ has four connecting protrusions 13, 13′ that are angularly displaced from each other. Each of the protrusions 13 of the outer ring 115 of the first housing half 11 is formed with a retaining hole, and is aligned with and is stacked above a respective one of the protrusions 13′ of the outer ring 115′ of the second housing half 11′ for extension of a fastener (not shown) through the retaining holes in the stacked protrusions 13, 13′ so as to fasten the first housing half 11 to the second housing half 11′.

The first and second housing halves 11, 11′ are made from an insulator material, such as phenol formaldehyde or carbon fiber-reinforced composite.

In this embodiment, the core-receiving space 12 has a loop shape, and is annular. However, in some embodiments, the core-receiving space 12 can be rectangular or oval in shape, or have a U-shape, I-shape, or E-shape.

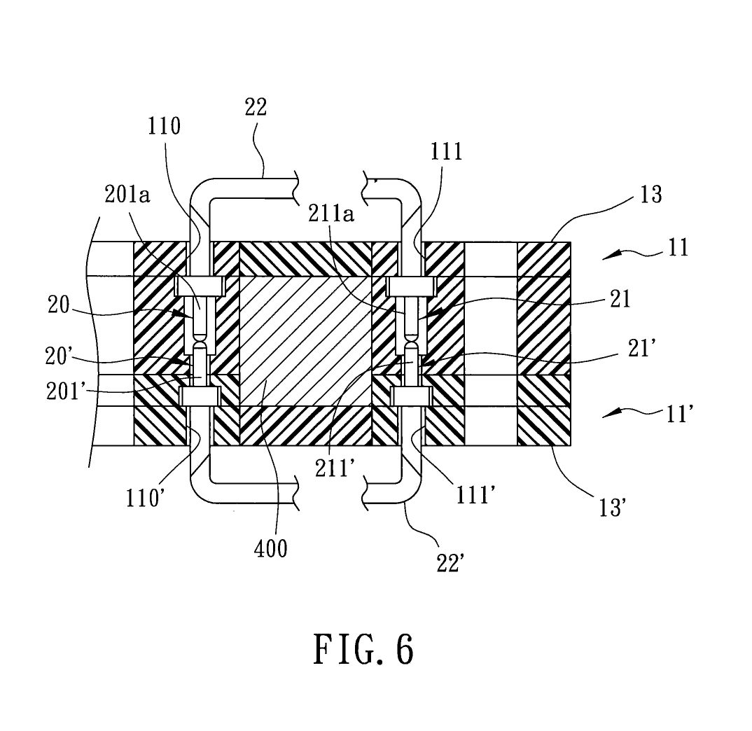

FIG. 6 illustrates the second preferred embodiment of the electromagnetic winding assembly 1 according to this invention. The second preferred embodiment differs from the previous embodiment in that each of the first inner connectors 20 and the first outer connectors 21 has a prong portion 201a, 211a. Each of the second inner connectors 20′ and the second outer connectors 21′ has a prong portion 201′, 211′. The prong portion 201′, 211′ of each of the second inner connectors 20′ and the second outer connectors 21′ extends outwardly of the respective one of the inner and outer through-holes 110′, 111′ in the second housing half 11′ and into a respective one of the inner and outer through-holes 110, 111 in the first housing half 11 to contact the prong portion 201a, 211a of the respective one of the first inner connectors 20 and the first outer connectors 21 in a press contact manner. The tips of the prong portions 201a, 211a, 201′, 211′ to be in contact with each other can be made from platinum.

It is noted that the number of the turns of each of the coil-like electrical conductors 6, 6′ can be varied according to the actual requirements, and can be adjusted by adjusting the numbers of the first and second conductive wires 22, 22′ to be used in the electromagnetic winding assembly 1.

With the inclusion of the first and second housing halves 11, 11′ and the first and second conductive units 2, 2′ in the electromagnetic winding assembly 1, the aforesaid drawbacks associated with the prior art can be eliminated.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. An electromagnetic winding assembly comprising:
first and second housing halves; and
first and second conductive units provided on said first and second housing halves, respectively;
wherein said first and second housing halves are detachably connected to each other so as to define cooperatively a core-receiving space therebetween and to connect electrically said first conductive unit with said second conductive unit such that said first conductive unit cooperates with said second conductive unit to form at least one coil-like electrical conductor configured to be wound around a core that is received in said core-receiving space.

2. The electromagnetic winding assembly of claim 1, wherein each of said first and second housing halves is formed with a plurality of angularly displaced inner through-holes and a plurality of angularly displaced outer through-holes, said first conductive unit including a plurality of first inner connectors that are inserted respectively into said inner through-holes in said first housing half, a plurality of first outer connectors that are inserted respectively into said outer through-holes in said first housing half, and a plurality of angularly displaced first conductive wires, each of which is connected electrically to a respective one of said first inner connectors and a respective one of said first outer connectors, said second conductive unit including a plurality of second inner connectors that are inserted respectively into said inner through-holes in said second housing half, a plurality of second outer connectors that are inserted respectively into said outer through-holes in said second housing half, and a plurality of angularly displaced second conductive wires, each of which is connected electrically to a respective one of said second inner connectors and a respective one of said second outer connectors, each of said first inner connectors being connected electrically to a respective one of said second inner connectors, each of said first outer connectors being connected electrically to a respective one of said second outer connectors.

3. The electromagnetic winding assembly of claim 2, wherein each of said first inner connectors and said first outer connectors has a socket portion, each of said second inner connectors and said second outer connectors having a prong portion, said prong portion of each of said second inner connectors and said second outer connectors extending outwardly of the respective one of said inner and outer through-holes in said second housing half and into a respective one of said inner and outer through-holes in said first housing half to engage releasably said socket portion of the respective one of said first inner connectors and said first outer connectors in a male-and-female engaging manner.

4. The electromagnetic winding assembly of claim 1, wherein said core-receiving space is loop-shaped.

5. The electromagnetic winding assembly of claim 1, wherein said first conductive unit cooperates with said second conductive unit to form a pair of said coil-like electrical conductors configured to be wound around the core, each of said coil-like electrical conductors having a plurality of turns, said turns of one of said coil-like electrical conductors being alternately disposed with said turns of the other of said coil-like electrical conductors.

6. The electromagnetic winding assembly of claim 2, wherein each of said first inner connectors and said first outer connectors has a prong portion, each of said second inner connectors and said second outer connectors having a prong portion, said prong portion of each of said second inner connectors and said second outer connectors extending outwardly of the respective one of said inner and outer through-holes in said second housing half and into a respective one of said inner and outer through-holes in said first housing half to contact said prong portion of the respective one of said first inner connectors and said first outer connectors.
